(19) United States
(12) Patent Application Publication
(10) Pub. No.: US 2014/0036072 A1
(43) Pub. Date: Feb. 6, 2014

(54) CARGO SENSING

(71) Applicant: Honeywell International Inc., Morristown, NJ (US)

(72) Inventors: Ronald Lyall, Tewkesbury (GB); Pedro Davalos, Plymouth, MN (US); Sharath Venkatesha, Minnetonka, MN (US); Donald Anderson, Locke, NY (US); Ynjiun P. Wang, Cupertino, CA (US); Scott McCloskey, Minneapolis, MN (US); John Hatherall, Tewkesburym (GB); Steve Howe, Morristown, NJ (US)

(21) Appl. No.: 13/923,259

(22) Filed: Jun. 20, 2013

Related U.S. Application Data
(60) Provisional application No. 61/662,106, filed on Jun. 20, 2012.

(51) Int. Cl. G06K 9/00

(52) U.S. Cl. CPC G06K 9/00771
USPC 348/143

(57) ABSTRACT

Cargo presence detection devices, systems, and methods are described herein. One cargo presence detection system includes one or more sensors positioned in an interior space of a container, and arranged to collect background image data about at least a portion of the interior space of the container and updated image data about the portion of the interior space of the container and a detection component that receives the image data from the one or more sensors and identifies if one or more cargo items are present in the interior space of the container based on analysis of the background and updated image data.

### TECHNICAL FIELD

The present disclosure relates to devices, methods, and systems for cargo sensing.

### BACKGROUND

Cargo container operators, shipping logistic entities, or freight operators often need to manage and track a large fleet of cargo shipping containers or trailers (as used herein, the term “container” will be used generally to include cargo and other types of containers, storage areas, and/or trailers). However, it can be difficult to tell which containers are full and which are empty or to track full and/or empty containers, for example, in a shipping yard filled with cargo containers.

### BRIEF DESCRIPTION OF THE DRAWINGS

FIG. 1 illustrates a container having an image based cargo sensing functionality in accordance with one or more embodiments of the present disclosure.

FIG. 2 illustrates another container having an image based cargo sensing functionality in accordance with one or more embodiments of the present disclosure.

FIG. 3 illustrates another container having a cargo sensing functionality using light curtains in accordance with one or more embodiments of the present disclosure.

FIG. 4 illustrates another container having a cargo sensing functionality in accordance with one or more embodiments of the present disclosure.

FIG. 5 illustrates images of the container with and without cargo using the background subtraction based method in accordance with one or more embodiments of the present disclosure.

FIG. 6 illustrates a computing device for providing image based cargo sensing in accordance with one or more embodiments of the present disclosure.

### DETAILED DESCRIPTION

Devices, methods, and systems for cargo sensing are described herein. In the present disclosure, the monitored entity can, for example, be the load-carrying space of a truck or trailer. As discussed above, containers, as used herein, tend to fall into various types of storage spaces including, but not limited to: the package space of a parcel van, the trailer space where a trailer is towed by a separate tractor unit, or a container space where a demountable container is carried on a flat bed trailer.

Embodiments of the present disclosure can detect the presence of one or more cargo items in a container and decide if the container is empty or non-empty through one or more imaging sensors, infrared sensors, executable instructions (e.g., software algorithms), and a processing unit (e.g., for executing the instructions). The software and processing unit can be used to analyze the sensor's imaging (e.g., video) output.

Cargo presence detection in shipping/storage containers would allow logistics operators to improve asset management, improve shipping fleet management, and/or improve inventory tracking. Additional benefits might include automated shipping container volume utilization measurement and/or tracking, security monitoring, and/or intrusion detection.

Shipping containers and trailers may have various configurations including: trailer/container length from 20 to 53 feet, height and width typically 10 feet×8 feet, zero to five “roller doors” down each side, a roller or barn door at the rear end, roof constructed of either metal or fiberglass, and have metal or wooden walls, floor, and/or doors. For example, non-empty containers can refer to trailers that contain at least one cargo package (e.g., a 4×4×4 foot cargo package). However, the empty vs. non-empty detection functionality described herein could also apply to closets or storage rooms and areas with similar characteristics. As used herein, cargo items can be one or more boxes, items being shipped (e.g., tires, toys, etc,), pallets of items or boxes, or other items that would be beneficial to be identified using such systems as are disclosed herein.

Additional cargo sensing system components that may be utilized include supplementary lights or flashes, either visible, infrared (IR), and/or near-infrared (NIR), co-located near the imaging sensor (e.g., camera) and pointed in the direction of or viewable within the sensor's field of view in order to enhance the lighting conditions if the container has a dark or low light environment. Further, cargo sensing components that may be utilized include external markers, stickers, reflectors, coded patterns, an/or light emitting sources such as LED's that would be placed on the container interior (e.g., side walls, roof, floor) as references for alignment or as references for establishing the baseline of an empty container, such that as cargo items are placed into the interior space of the container, any obstructions or discontinuities of the markers would indicate the presence of one or more cargo items.

Possible examples of video based imaging sensors that can be used for this cargo sensing system include any standard imaging camera/webcam (complementary metal oxide semiconductor (CMOS) or charge coupled device (CCD) sensor), or other specialized imaging sensors or Passive Infra-Red (PIR) sensors. Possible software algorithms that would analyze the video based image data sensor output include, for example, one of the following, or any combination of the following:

In some embodiments, feature detection can be utilized to detect one or more cargo items. For example, an initial baseline calibration image (reference image) with the container being empty can be captured for a specific container, using, for example, assisted lighting illuminators and/or flashes, as needed if under low-light conditions, and then specific distinctive features can be located and computed. After this initial empty baseline calibration, subsequent snapshot images can be captured in the same fashion, and features from the baseline empty calibration image data are used for comparison. Candidates for feature detectors include: speeded up robust feature (SURF), scale-invariant feature transform (SIFT), histogram of oriented gradients (HOG), GIST, maximally stable extremal regions (MSER) or extensions of a Harris comer detector.

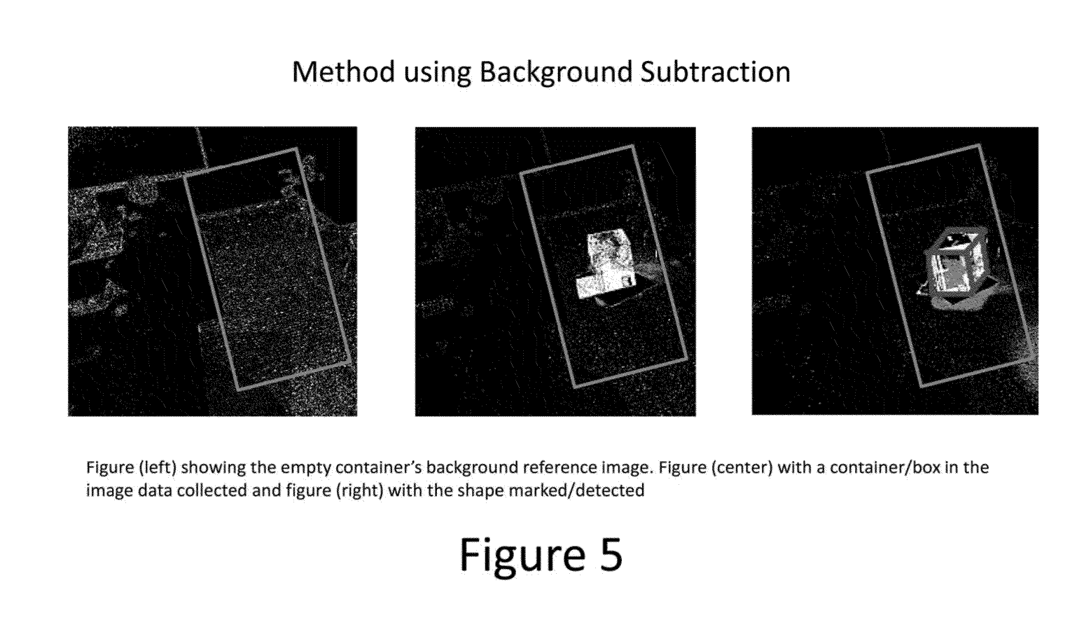

As illustrated in the embodiment of FIG. 5, any areas that show differences can be considered as potential cargo items and the dimensions can be estimated. Pre-set camera calibration parameters and camera sensor placement calibration may be used to estimate the detected cargo item dimensions.

In some embodiments, scene change can be utilized to detect one or more cargo items. For instance, such a method can be used to detect boxes or other cargo, for example, for up to a distance of 20 feet and/or estimate their approximate dimensions. The hardware can, for example, include a CCD/CMOS imaging sensor (e.g., camera) with a field of view (FOV) of, for example, 60 degrees and a sufficient depth of field and sufficient illumination for detecting one or more cargo items within the interior space of the container. A commercial off the shelf (COTS) web camera with incandescent lighting is an example of a suitable device.

Such methods can involve obtaining a reference image of the container when it is empty and comparing it with subsequent image data (updated image data) of the interior space of the container with one or more cargo items. A background subtraction method, for example using Gaussian Mixture Models (GMM) or its variants can be used to separate the background (e.g., empty container) from the foreground (e.g., cargo).

In some such embodiments, the one or more cargo items may appear as blobs in a binary image. The blobs can be identified in a region of interest (ROI), and in the case of an embodiment shown in FIG. 5, the ROI is the fitted ground plane region corresponding to the container floor. The blobs can then be used for further analysis.

Using the imaging sensor's extrinsic parameters and using a ground plane reference from the reference image, the approximate size of the one or more cargo items (e.g., ˜6 inches of accuracy in some embodiments, subject to lighting constraints) can be estimated. In some embodiments, if the size of the one or more cargo items is greater than that of the required cargo detection thresholds, the system flags success for detection.

Such a method can be extended by using an infra-red (IR) assisted illumination and a camera with good response in the IR wavelengths. An advantage of using an IR illuminator method is that it is independent of illumination variations in the visible spectrum. Also, the effect of shadows, which can lead to false positives in background subtraction, can be reduced, in some embodiments.

In some embodiments, marker occlusion can be utilized to detect one or more cargo items. For example, specific visible markers (active or passive) as previously described can be placed, for example, along surfaces (e.g., the side walls) of the interior space of the container. An initial baseline calibration image would be captured for establishing the empty baseline, and subsequent captured images would be analyzed and searched for markers, for example, with the same marker localization process as the baseline image.

Any discrepancies in the localized markers from the test image versus the baseline image can be determined to constitute an obstructed marker that would imply and indicate the presence of one or more cargo items in the interior space of the container. In some such embodiments, the one or more markers and the one or more imaging sensors can be placed at strategic locations that would be considered as interesting with respect to marker occlusion.

For instance, the markers can be placed at a minimum height that the one or more cargo items need to be detected, such as 3 feet above the floor in the interior space of the container, for example, to avoid debris or tools that may often be left in the container, and/or to ignore any objects smaller than 3 feet high. For example, cargo containers may have empty pallets; carts, dollies, ropes, etc. therein and executable instructions can be provided to exclude such items from analysis and/or the minimum height could be set such that those items would be below the minimum height.

In some embodiments, the baseline imagery can also be captured with items in tie container that may be continually kept in the container and therefore should not be considered for analysis as one or more cargo items. In such embodiments, these items can then be excluded from consideration either through computing device executable instructions, or by a user reviewing the imagery.

In some embodiments, edge information can be utilized for cargo detection. For instance, edge images can be computed and/or generated through, for example, a visible sensor with an edge detector algorithm such as Canny or Sobel, or edge image data can used to generate edge images with a log edge sensor. These edge images (or the data used to generate the images) can be compared against a baseline empty edge image (or the data used to generate the baseline edge image), and any discrepancies can be considered as potential cargo items.

In some embodiments, light curtains can be utilized for cargo detection. For example, light curtains utilize an IR transmitter and receiver pair. The transmitter projects an array of parallel IR light beams to the receiver which utilizes a number of photoelectric cells. When an object breaks one or more of the beams, the presence of an object is detected.

An array of these light curtains can, for example, be installed at equal distance intervals (e.g., 4 feet) to detect the presence of one or more cargo items.

In some embodiments, movable devices (e.g., robotic devices) can be utilized to sense one or more cargo items. For example, a device can be motor wheel based or may be circular or disc shaped to enable rolling.

In some embodiments, the movable robotic device can have one or more imaging/IR sensors (e.g., imaging cameras, RFID location identification devices, inertial measurement units (NU) and/or infrared ranging imagers) thereon. A computing device, for example, on board the container can be utilized to act as a server device to collect information from multiple sensors mounted on one or more movable devices.

The imaging/IR sensors and/or ranging device can be utilized to confirm that the device is in close proximity of a cargo item and also can ascertain the distance of the robotic device from the cargo item. A camera can also allow a user to see into the interior space of the container, among other benefits.

The location identification device, which can be RFID based, can help to identify the precise location of the movable device in the container and the NU can be utilized to help to determine the camera view angle. The images thus obtained from the one or more cameras along with the location information and/or camera view angle can he used to estimate the approximate dimensions of the package.

Previous systems for detecting the presence of one or more cargo items in trailer containers have used ultrasonic range sensors. However, an approach using video-based imaging and/or infrared sensors, as discussed regarding various embodiments herein, allows for a measurement system that can provide accurate cargo detection. Furthermore, added benefits of video based imaging sensor are the visible (grayscale or RGB) image, which may he presented to a user for verification of the system's output.

As discussed above, a cargo sensing system can, for example, include a video based imaging sensor (e.g., camera), one or more computing device executable instructions (e.g., including software algorithms), and a processing unit (e.g., a central processing unit (CPU)), as well as possible illuminators (e.g., light sources and/or flashes), and also possible markers (e.g., coded patterns and/or reflectors) to be used as references along the container surfaces (e.g., side walls). Depending on the image sensor's detection range and viewing angle, there may be several image sensor placement configuration options. For example, an image sensor and an illuminator flash may be placed on the overhead ceiling pointing down or at an angle.

In some embodiments, due to limitations of the maximum detection range and/or field of view of some image sensors, full scanning, monitoring, and/or measuring of large containers can be achieved by one of several options including, for example, a network of multiple fixed mounted sensors, a moving or sliding sensor (e.g., using a rail system), or panning and/or tilting a sensor at a fixed location.

Reference markers may be utilized, in some embodiments, by being placed at fixed positions along the container. Markers could remain visibly consistent throughout the operating lifetime of the system installation per container. Yet, in some embodiments, the system may employ adaptive tracking and learning algorithms that would allow degradation through wear and tear of the visible coded markers.

A processing unit can be utilized to control one or more imaging sensors, control one or more light sources (e.g., external illuminator flashes), handle image acquisition, and/or execute computing device readable instructions (e.g., run one or more software algorithms to analyze the image data). The system can include executable instructions, far example, to perform cargo sensing measurements at pre-determined sampling intervals. Additionally, analyzing large containers where panning, tilting, and/or sliding a sensor is utilized to cover an area of interest, can, for example involve possessing multiple individual frames, or snapshots, from the sensor.

In various embodiments, where an array of sensors is utilized within the interior space of a container, if any of the sensors from the different areas under surveillance detects a cargo item, the container can be considered to be non-empty. The empty vs. non-empty decision from the cargo sensing system can then be relayed to an operator or a central container tracking and processing unit.

In various embodiments, a processing unit can be programmed with executable instructions (e.g., software algorithms) that can analyze an imaging sensor's image data. These algorithms can, for example, employ one or more of the following approaches.

One such approach is image background subtraction, wherein a baseline empty image (or baseline image data) is compared with another, updated image (or updated image data) of the container (i.e., taken after the baseline image). A threshold to a difference operator can then be applied and each region that exceeds the difference threshold can be analyzed as possible cargo item candidates.

Each area within a region that exceeds the threshold can be referred to as a cargo item candidate blob. These cargo item candidate blobs can be further analyzed for region blob properties and texture comparison. For example, the blob properties can provide dimension information, and the texture properties can be further compared with the baseline image for a higher confidence that the region is indeed cargo and not part of the container surface.

Another approach involves imaging sensor placement at a lower position (e.g., along a side wall) such that the imaging sensor's height can define the virtual plane (e.g., horizontal plane) along the container, this virtual plane can be utilized, for example, to define a minimum detection height of cargo items. In such an embodiment, any objects, blobs, or regions that are found to be different from the baseline image above this plane could be utilized to constitute a non-empty container system decision. Any objects, blobs, or regions below this virtual plane could be ignored for the empty vs. non-empty decision.

In some embodiments, this virtual plane concept can be accomplished via executable instructions and would thereby, not require any markers to be placed in the container. However, markers along the virtual plane could potentially assist in the comparison operation and therefore may be utilized, in some embodiments.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” “a number of” something can refer to one or more such things. For example, “a number of” sensors can refer to one or more sensors.

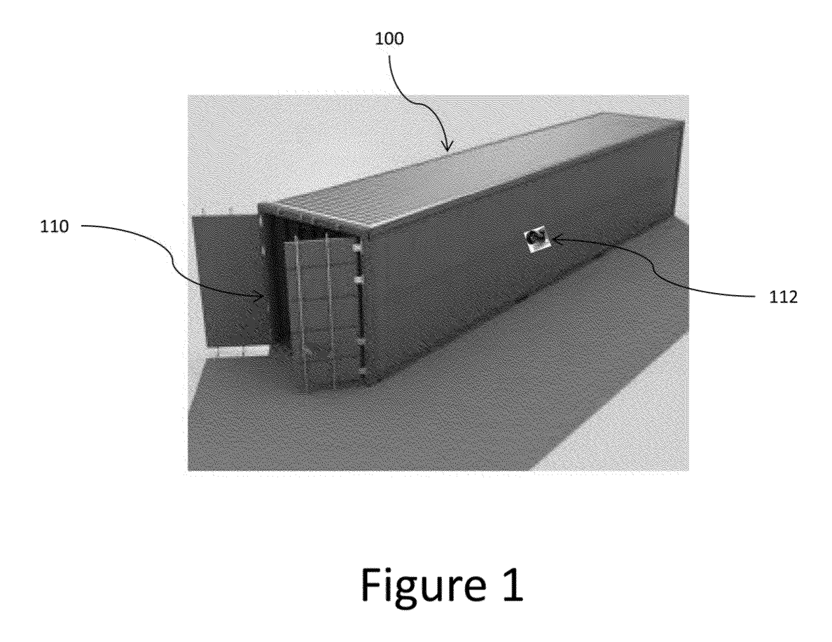

FIG. 1 illustrates a container having an image based cargo sensing functionality in accordance with one or more embodiments of the present disclosure. In various embodiments, one or more imaging sensors 112, that provide image data to the system, can be positioned in any suitable location within the container 110. In the embodiment illustrated in FIG. 1, the container 100 has one image sensor therein.

In this embodiment, a single camera 112 is movably mounted so that it can traverse from one end of the interior of container 110 to the other. In some embodiments, the imaging sensor may not need to traverse all the way from one end to the other.

As discussed above, in some embodiments, an imaging sensor may be fixed to the container, but may be capable of panning and/or tilting. A panning and/or tilting arrangement can also be utilized with imaging sensors that are not fixed to the container.

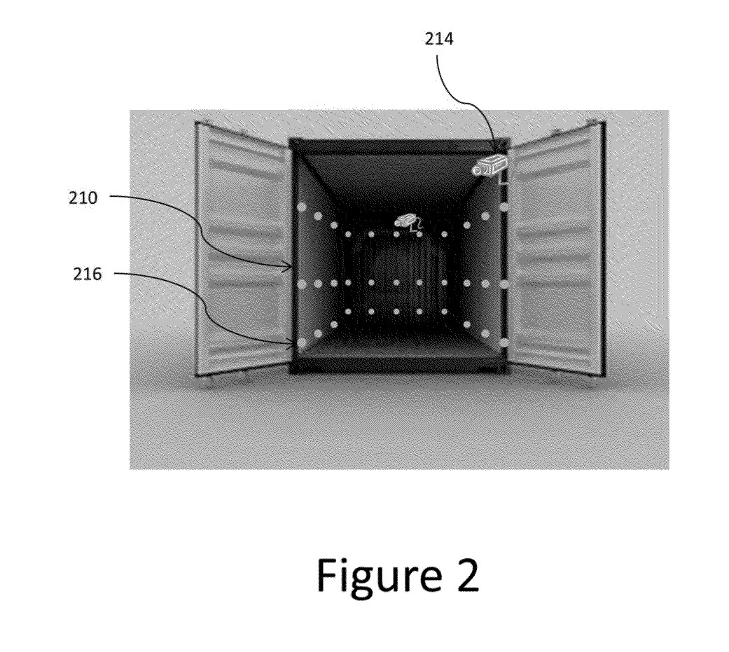

FIG. 2 illustrates another container having an image based cargo sensing functionality in accordance with one or more embodiments of the present disclosure. In the embodiment of FIG. 2, the container includes multiple imaging sensors 214 and utilizes a number of markers 216 on the interior surface 210 of the container.

The markers can be any suitable indicators. Examples include non-illuminating or reflecting indicators applied to the surface of the container, reflectors, and/or light sources (e.g., incandescent or light emitting diodes, phosphorescent materials).

In embodiments as illustrated in FIG. 2, a cargo item positioned within the container will obscure one or more of the markers and as such, the images from the imaging sensor will capture the obscuring of the markers. When the one or more captured images is compared to the baseline image, it can be determined that the container is not empty.

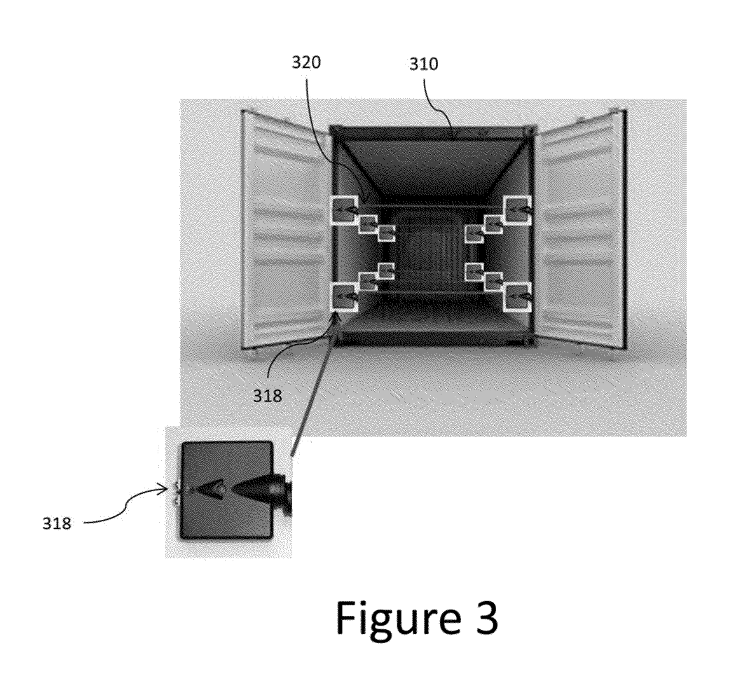

FIG. 3 illustrates another container having a cargo sensing functionality in accordance with one or more embodiments of the present disclosure. In the embodiment of FIG. 3, one or more sensor elements 318 are provided in the interior of the container 310. In this embodiment the sensor elements are paired together and a beam 320 is provided between the elements.

In embodiments as illustrated in FIG. 3, a cargo item positioned within the container will block one or more of the beams between the sensor elements and, as such, it can be determined that the container is not empty. Although sensor elements are paired in the illustrated embodiment, other implementations can be accomplished where multiple sensor elements are used other than two and can be in a variety of different positions within the container. Sensor elements can include transmitters, receivers, transceivers, mirrors, beam splitters, and other such elements.

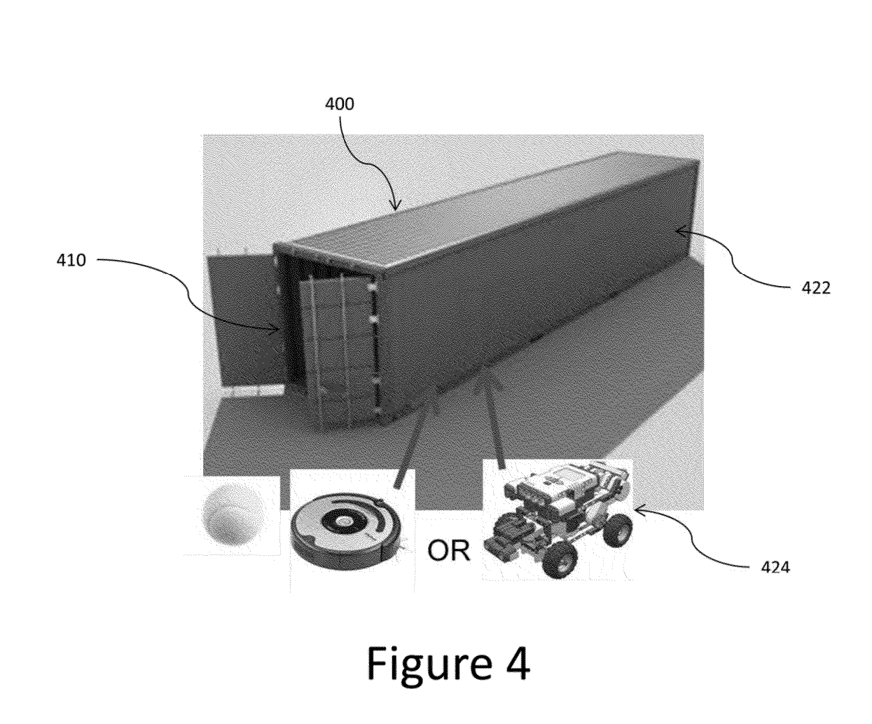

FIG. 4 illustrates another container having an image based cargo sensing functionality in accordance with one or more embodiments of the present disclosure. In the embodiment of FIG. 4, one or more movable sensor devices 424 are provided. In such embodiments, the sensor devices can be robotic devices or passive movable devices (e.g., spherical shapes having one or more sensors thereon that move either randomly or in a systematic or controlled path 422 within the container 410.

In embodiments as illustrated in FIG. 4, a cargo item positioned within the container will block the path of the one or more movable devices and, as such, it can be determined that the container 400 is not empty. In such an embodiment, imaging/IR sensors may not be mounted on the device, if presence or absence of cargo items is desired, however, the present disclosure is not so limited.

In some embodiments, the one or more movable devices may have markers thereon and one or more sensors on the interior of the container can track the movement of the devices. In such a manner, the sensors can detect when the device is blocked by a cargo item based upon the disruption of the device's path of movement.

FIG. 5 illustrates images of the container with and without one or more cargo items using the>background subtraction based method in accordance with one or more embodiments of the present disclosure. In the picture to the left, the image represents the empty container's background reference image. The center picture represents the container with a cargo item (a box) located within the container. The picture to the right represents the cargo item's shape being detected and marked, indicating that the container is not empty.

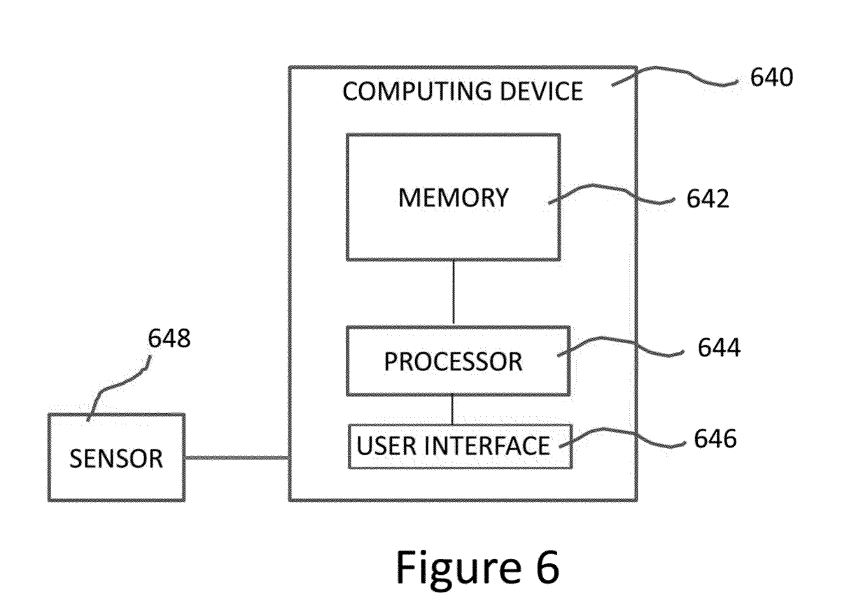

FIG. 6 illustrates a computing device 640 for providing a diagnosis of a system of a building in accordance with one or more embodiments of the present disclosure. Computing device 640 can be, for example, a laptop computer, a desktop computer, or a mobile device (e.g., a mobile phone, a personal digital assistant, etc.), among other types of computing devices.

As shown in FIG. 6, computing device 640 can include a memory 642, a processor 644 coupled to memory 642, one or more user interface components 646, and the computing device 640 can be coupled wired or wirelessly to one or more sensors 648. As discussed above, several types of suitable sensors 648 can be utilized in the various embodiments discussed herein.

Memory 642 can be any type of storage medium that can be accessed by processor 644 to perform various examples of the present disclosure. For example, memory 642 can be a non-transitory computing device readable medium having computing device executable instructions (e.g., computer program instructions) stored thereon that are executable by processor 644 to provide image based cargo sensing by analyzing data (e.g., image or movement data) received from the one or more sensors in accordance with one or more embodiments of the present disclosure.

Memory 642 can be volatile or nonvolatile memory. Memory 642 can also be removable (e.g., portable) memory, or non-removable (e.g., internal) memory. For example, memory 642 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 642 is illustrated as being located in computing device 640, embodiments of the present disclosure are not so limited. For example, memory 642 can also be located internal to another computing resource (e.g., enabling computer executable instructions to be downloaded over the Internet or another wired or wireless connection).

As shown in FIG. 6, computing device 640 can also include a user interface 646. User interface 646 can include, for example, a display (e.g., a screen). The display can be, for instance, a touch-screen (e.g., the display can include touch-screen capabilities).

User interface 646 (e.g., the display of user interface 646) can provide (e.g., display and/or present) information (e.g., image and/or movement data) to a user of computing device 640. For example, user interface 646 can provide a display of possible areas, regions, blobs that may contain one or more cargo items, location information regarding which containers are empty or not empty, and/or statistics regarding which containers are empty or not empty, as previously described herein.

Additionally, computing device 640 can receive information from the user of computing device 640 through an interaction with the user via user interface 646. For example, computing device 640 can receive input from the user, such as a determination as to where a container is empty or not based upon the user's analysis of the information provided by the one or more imaging sensors, as previously described herein.

The user can enter the input into computing device 640 using, for instance, a mouse and/or keyboard associated with computing device 640 (e.g., user interface 646), or by touching user interface 646 in embodiments in which user interface 646 includes a touch-screen. Such processes can be accomplished locally (near the container) or remotely with respect to the container (at a location not near the container).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures, and methods are used. In the foregoing Detailed Description, various features are grouped together in example embodiments illustrated in the figures for the purpose of streamlining the disclosure. Accordingly, inventive subject matter lies in less than all features of a single disclosed embodiment.

1. A cargo presence detection system, comprising:
one or more sensors positioned in an interior space of a container, and arranged to collect background image data about at least a portion of the interior space of the container and updated image data about the portion of the interior space of the container; and
a detection component that receives the image data from the one or more sensors and identifies if one or more cargo items are present in the interior space of the container based on analysis of the background and updated image data.

2. The cargo presence detection system of claim 1, wherein the detection component compares the background data and updated data to identify differences and then analyzes the differences to determine whether the differences represent one or more cargo items.

3. The cargo presence detection system of claim 1, wherein at least one of the one or more sensors is an active infra-red or near infra-red three dimensional sensor.

4. The cargo presence detection system of claim 1, wherein the image data provided by the one or more sensors includes at least one of: depth information and three dimensional points.

5. The cargo presence detection system of claim 1, wherein at least one of the one or more sensors is movable within the interior of the container.

6. The cargo presence detection system of claim 5, wherein the system includes one or more markers that can be positioned within the container and used to identify if one or more cargo items are present within the container.

7. The cargo presence detection system of claim 1, wherein at least one of the markers is provided on a movable device.

8. A cargo presence detection system, comprising:
one or more vision based sensors positioned in an interior space of a container, and arranged to provide image data about at least a portion of the interior space of the container;
one or more markers positioned within the container that, when obscured in the image data, indicate the presence of one or more cargo items; and
a detection component that receives the image data from the one or more sensors and identifies if one or more cargo items are present in the interior space of the container based on analysis of the image data.

9. The cargo presence detection system of claim 8, wherein one or more of the markers is illuminated.

10. The cargo presence detection system of claim 8, wherein the system includes one or more light sources to illuminate the interior of the container.

11. The cargo presence detection system of claim 8, wherein the detection component analyzes the image data by comparing baseline image data with updated image data.

12. The cargo presence detection system of claim 8, wherein the detection component utilizes a feature detectors process selected from the group including: speeded up robust feature (SURF), scale-invariant feature transform (SIFT), histogram of oriented gradients (HOG), GIST, maximally stable external regions (MSER), and extensions of a Harris comer detector.

13. The cargo presence detection system of claim 8, wherein detection component receives data from the one or more sensors and determines if any objects identified from the data exceed a pre-specified volume or size threshold.

14. A cargo presence detection system, comprising:
one or more sensors in an interior space of a container to provide image data about at least a portion of the interior space of the container, wherein the one or more sensors collect data regarding a first area of the interior space of the container and then move to collect data regarding a second area of the interior space of the container; and
a detection component that receives the image data from the one or more sensors and identifies if one or more cargo items are present in the interior space of the container based on analysis of the image data.

15. The cargo presence detection system of claim 14, wherein the one or more of the sensors are light curtains.

16. The cargo presence detection system of claim 14, wherein the detection component analyzes the image data by identifying edges within the image data and determining whether the edges identified represent a portion of one or more of the cargo items.

17. The cargo presence detection system of claim 14, wherein the image data can identify one or more dimensions of one or more of the cargo items.

18. The ergo presence detection system of claim 14, wherein the image data can identify a first image dimension of one or more of the cargo items and that dimension can be used to estimate one or more other dimensions of the cargo item.

19. The cargo presence detection system of claim 14, wherein the sensors can be positioned to ignore certain portions of the container.

20. The cargo presence detection system of claim 14, wherein the detection component analyzes the image data by subtracting background image data from a received image data set.
